(19) United States
(12) Patent Application Publication
(10) Pub. No.: US 2010/0020020 A1
(43) Pub. Date: Jan. 28, 2010

(54) System and Method for Typing Using Fingerprint Recognition System

(76) Inventor: Yuannan Chen, Cincinnati, OH (US)

Correspondence Address: Yuannan Chen, 1079 Stream Ridge Ln, Cincinnati, OH, 45255, US

(21) Appl. No.: 11/940,564

(22) Filed: Nov. 15, 2007

(51) Int. Cl. G06F 3/041

(52) U.S. Cl. 345/173; 382/181

(57) ABSTRACT

A Method for typing utilizes biometric fingerprint recognition with one hand and its thumb and fingers representing the selection of choices from 1 to 5—with thumb selects 1, index finger selects 2, middle finger selects 3, ring finger selects 4 and pinky selects 5. A touchpad with built in fingerprint reader can be used to recognize which finger is pressing the touchpad.

The 26 letters will be divided into 6 groups. The first press on the touchpad invokes the corresponding group with 5 characters or symbols and the second press picks the respective character within the group. While pressing both the thumb and index fingers on the surface at the same time activates the 6^{th} section that contains letter Z and 4 other commonly used symbols.

### FIELD OF THE INVENTION

This invention relates generally to the field of data entry for personal digital assistants (PDA) or cell phones. More specifically, the invention set forth here is particularly ideal for one-handed blind typing with the other hand in an easy and natural manner; thus it is a better alternative to miniature keyboard or on-screen keyboard that are widely used on Personal Digital Assistants (PDAs) or keypads on cell phones.

### BACKGROUND OF THE INVENTION

Data input on Personal Digital Assistants (PDA) usually rely on on-screen keyboard or miniature keyboard. Due to the size of the virtual keyboard, the user usually finds it cumbersome, distractive, error-prone and unintuitive to stroke characters over such small keyboard. In addition, keyboard is primarily designed for two-handed typing that is quite different from PDA while user usually has only one hand free for typing. Numerical Keypads, commonly used on cell phones, are even more cumbersome for data entry since it requires multiple strikes on the key in restricted time interval to type a character. Furthermore, both keyboard (either on-screen or miniature) and keypad take too much valuable space from the PDA whose sizes matter to customers.

Despite the growing use of fingerprint recognition for identification and verification, no electronic device has ever taken its advantages and applied it for data entry. It is common knowledge that every finger has unique fingerprints and can be identified through fingerprint readers. There are presently known electrical techniques for sensing fingerprints and converting the fingerprint pattern to electrical signals.

The present invention defines the method in how to use fingertip and fingerprints of only one hand to quickly type on a flat surface set forth here as touchpad with built in fingerprint reader and motion detector. Such touchpad set forth here can be used as data entry device on personal digital assistants (PDA) and cell phones.

### DESCRIPTION OF THE METHOD

The invention relies on a touchpad with built in fingerprint reader and motion detector. Device similar to such device is the touchpad on laptop computers for tracking mouse movements. However, the touchpad for laptop lacks fingerprint reading capability and is not for data entry. The touchpad set forth here requires the typist to record his/her fingerprints to the system before the fingerprints are recognizable. To do this, the typist should let the touchpad to scan the fingerprints of thumb and fingers and store the fingerprints in memory before using the device. When scanning fingerprints, the typist should provide the full fingerprints that covers up to fingertips that he/she may touch the touchpad when typing.

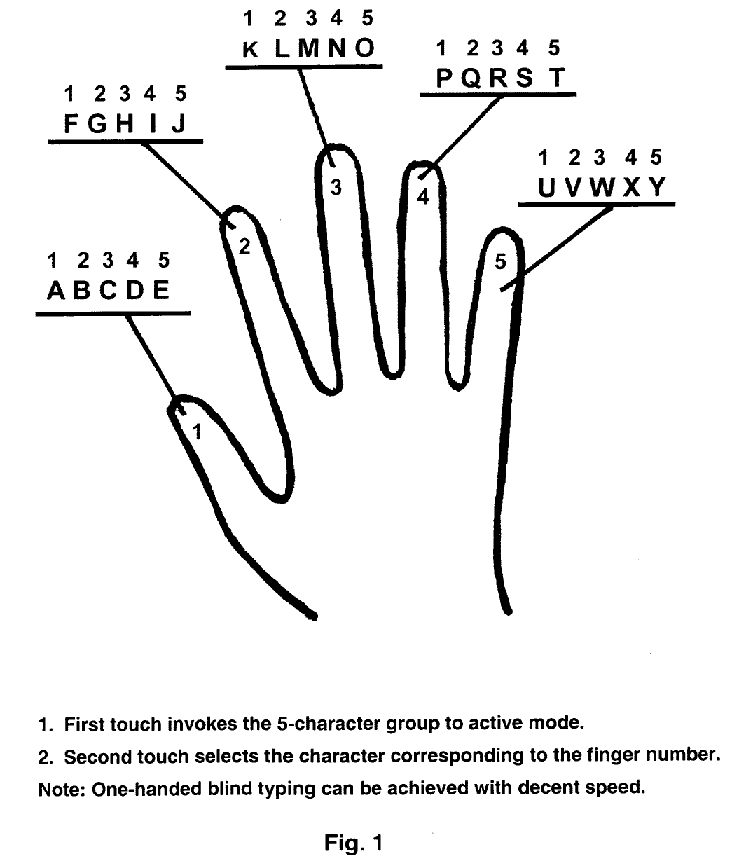

To efficiently and quickly type the alphabets, the invention set forth here divides the first 25 or the 26 alphabetic characters, from A to Y, into 5 groups (see FIG. 1). The numbers labeled on fingers represent group number. It requires two strokes to select a character.

1. First touch invokes the 5-character group to active mode.

2. Second touch selects the character corresponding to the finger number.

Note: one-handed blind typing can be achieved with decent speed.

Traditional typing requires the finger to actually press the key to make the selection; thus; it is sometimes error-prone since the typist often strikes wrong keys. The invention set forth here makes the selection based on the fingerprints touching the touchpad. The first touch invokes the corresponding alphabetic section comprising 5 characters. The second touch selects the letter corresponding to the finger number, with thumb indicates 1, and pinky indicates 5.

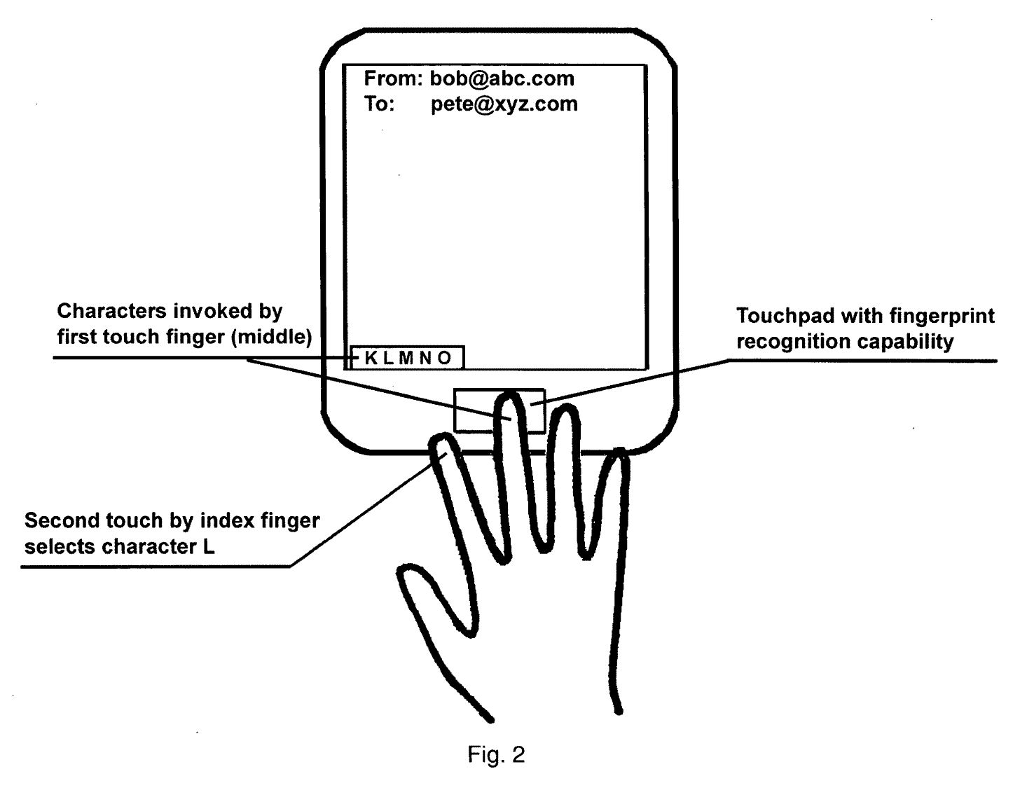

FIG. 2 is the schematic illustration how the invention can be used as the text input device on a Personal Digital Assistants (PDA). To type character L, the typist touches the touchpad with middle finger to invoke the section comprising KLMNO. L is the second character in the section; thus the typist can press the touchpad with index finger to select L. For novice typist using the method set forth here, displaying the characters of the invoked section in the screen after the first touch can help make the second selection, thus enhancing the typing speed.

Furthermore, let's illustrate the method in details that covers not only the 26 alphabetic characters, but also common symbols. The invention set forth divides the characters and symbols into 11 groups, as shown in Table 1.

TABLE 1
Division of letters and symbols in different groups.

| Group# | Characters or Symbols | Invoking Finger (s) |
|---|---|---|
| 1 | A B C D E | Thumb |
| 2 | F G H I J | Index |
| 3 | K L M N O | Middle |
| 4 | P Q R S T | Ring |
| 5 | U V W X Y | Pinky |
| 6 | Z , . ‘ “ | Thumb + Index |
| 7 | 1 2 3 4 5 | Index + Middle |
| 8 | 6 7 8 9 0 | Middle + Right |
| 9 | & $ @ ! # | Ring + Pinky |
| 10 | + − = % * | Thumb + Index |
| 11 | # / \| \ _{—} | Thumb + Middle |

As in table 1, each group of characters or symbols comprises exactly 5 items that match the five fingers of a hand starting from thumb to pinky representing 1 to 5 respectively.

After the fingerprint data has been scanned to system memory and the PDA device is in typing mode. The first touch of one or two fingers on the touchpad invokes the corresponding group comprising exactly 5 characters or symbols. In real application to PDA, such active group of characters or symbol can be displayed on screen to assist further selection. A second touch of one finger on the touchpad, starting from thumb to pinky selects the character or symbol corresponding to its position in the group.

The following table illustrates how to type some of the characters or symbols:

TABLE 2
Typing examples

| Character or | Group it | First Touch | Second Touch |
|---|---|---|---|
| Symbols | Belongs to | Finger(s) | Finger (selection) |
| B | 1 (ABCDE) | Thumb | Index (2) |
| H | 2 (FGHIJ) | Index | Middle (3) |
| K | 3 (KLMNO) | Middle | Thumb (1) |
| T | 4 (PQRST) | Ring | Pinky (5) |
| Y | 5 (UVWXY) | Pinky | Pinky (5) |
| Z | 6 (Z , . ‘ “) | Thumb + Index | Thumb (1) |
| 4 | 7 (12345) | Index + Middle | Ring (4) |
| 0 | 8 (67890) | Middle + Ring | Pinky (5) |
| $ | 9 (& $ @ ! #) | Ring + Pinky | Index (2) |

Moreover, there are still some commonly used keys on keyboard that are essential for typing, including Space, Enter, Backspace, Delete. These keystrokes can be simulated by dragging fingers over the touch pad surface. Touchpads on most Laptop computers already has motion detection capability.

While Space can be achieved by dragging any finger from left to the right and Backspace can be achieved by dragging any finger from right to the left. Enter can be achieved while dragging any finger from top to bottom. Delete can be achieved by dragging any 2 fingers from left to the right.

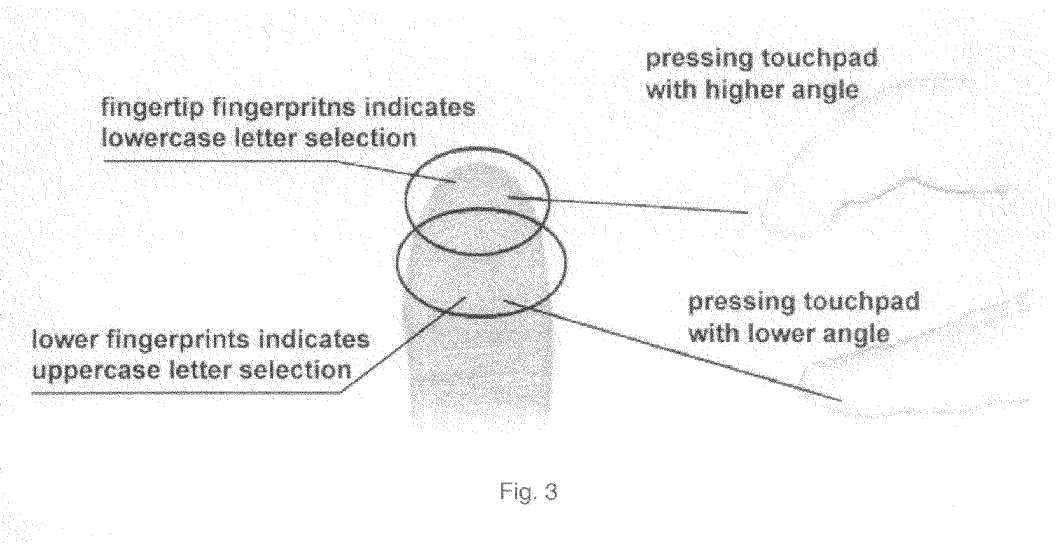

The invention set forth here differentiates the uppercase and lowercase letter by the way the finger pressing the touch pad. Adjusting the angle a finger pressing the touchpad can type letter in different cases. Most users are more adaptable for fingertip typing that leaves only the fingertip fingerprints. Thus, such fingerprints should indicate lowercase letters that are typed more often than uppercase letters. To type a letter in uppercase, the user should press the touchpad at lower angle that leaves the lower part of the fingerprints to touchpad (see FIG. 3).

With the above typing methods, a user can achieve quick one-handed blind typing with the other hand in an easy and natural manner. Such typing system can be used as data input device for handheld devices such as iPhones, iPod Touch, Pocket PC, cell phones and media players.

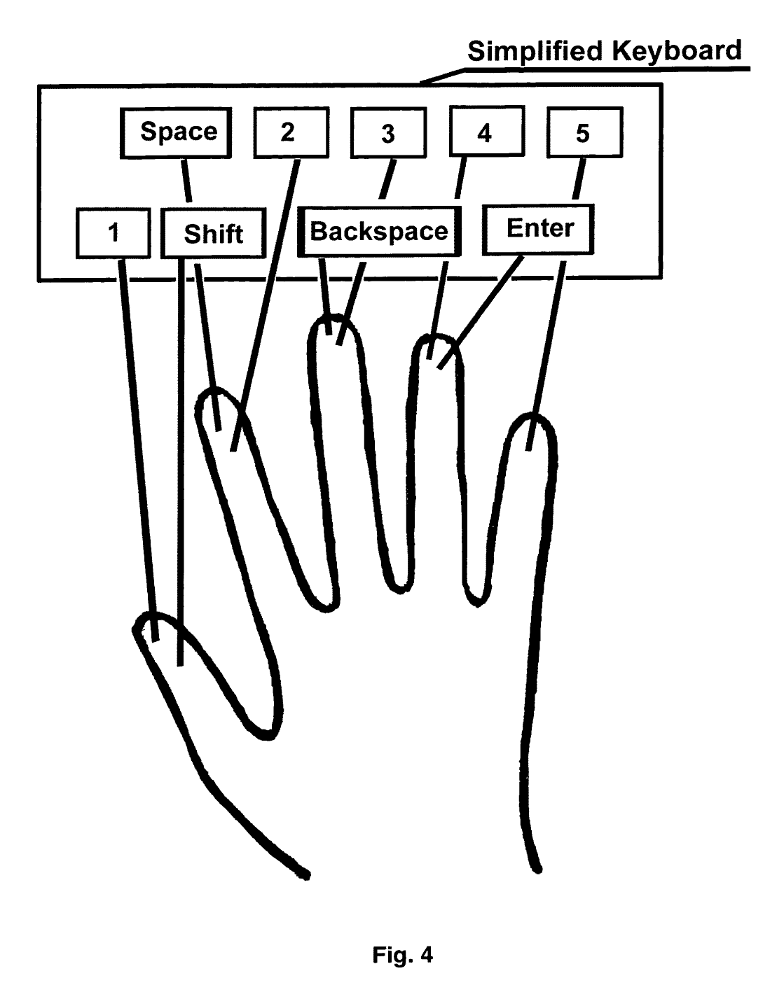

The present invention can be further applied to a simplified keyboard that is suitable for one-handed typing as shown in FIG. 4. The layout of the simplified keyboard has two rows of keys. The top row has buttons labeled for SPACE, 2, 3, 4, and 5. The bottom row has buttons labeled for 1, SHIFT, BACKSPACE, and ENTER. The typist will use thump for buttons 1 and SHIFT; use index finger for buttons SPACE and 2; use middle finger for buttons 3 and BACKSPACE; user ring finger for buttons 4 and ENTER; user pinky for button 5.

The advantage of such keyboard is that the fingers are allowed to stay on the assigned keys while typing, with thumb controlling button 1, index for button 2, middle for button 3, ring for button 4 and pinky for button 5. The key layout is adjusted to the comfortableness of the positions of fingers. The Shift button annexed to button 1 can be used for selecting uppercase letters. When the character is the first letter in the group, thumb can press both button 1 and button shift at the same time to type uppercase letter. Similar to the fingerprint typing method mentioned above, the first stroke on the button invokes the corresponding group of characters or symbols and the second stroke selects the corresponding character or symbol in the group. While pressing two buttons at the same time triggers the same group of characters as touching the two corresponding fingers on the touchpad.

Such simplified keyboards can be used on low-end handheld devices that lack the fingerprint recognition capability.

What is claimed is:

1. A data input system utilizing fingerprint recognition system:
a. storing fingerprints to the fingerprint characteristic data memory;
b. first finger touch invoking the corresponding section of characters or symbols to select;
c. second finger touch select the character corresponding to the finger pressing the fingerprint reader.

2. A data input system, as defined in claim 1, utilizes biometric fingerprints for typing.

3. A data input system, as defined in claim 1, utilizes a finger's fingerprints to make selections with thumb, index, middle, ring, pinky representing selection of choice 1, 2, 3, 4, 5 respectively.

4. A data input system, as defined in claim 1, utilizes a finger's fingerprints to invoke the group of 5 characters or symbols for further selection as in claim 3.

5. A data input system, as defined in claim 1, utilizes the touching fingerprints of two or more fingers to invoke a group of characters or symbols for further selection as in claim 2.

6. A typing method, as defined in claim 1, utilizes the finger's touching angle, more exactly, the fingerprint area read in of the same finger, to indicate upper or lower case letter.

7. A lighted keyboard comprising: 5 buttons adjusting to comfortableness of five-finger positions; a shift key in junction with the 5 button to make upper case selection; a few other keys including space, backspace; enter.

8. A lighted keyboard, as in claim 7, uses button 1, button 2, button 3, button 4, button 5 to make sub selection of choice 1, 2, 3, 4, 5 respectively.

9. The lighted keyboard of claim 7, uses two strikes to type an character: first strike to invoke the group of 5 characters for further selection as in claim 8.
